(19) United States
(12) Patent Application Publication
(10) Pub. No.: US 2026/0040361 A1
(43) Pub. Date: Feb. 5, 2026

(54) PRACH REPETITION USING DIFFERENT BEAMS

(71) Applicant: QUALCOMM Incorporated, San Diego, CA (US)

(72) Inventors: Mahmoud Taherzadeh Boroujeni, San Diego, CA (US); Qiaoyu Li, Beijing (CN); Changhwan Park, San Diego, CA (US); Rebecca Wen-Ling Yuan, San Diego, CA (US); Sanghoon Kim, San Jose, CA (US); Yan Zhou, San Diego, CA (US); Tao Luo, San Diego, CA (US); Hung Dinh Ly, San Diego, CA (US); Gokul Sridharan, Sunnyvale, CA (US)

(21) Appl. No.: 18/995,434

(22) PCT Filed: Jun. 22, 2023
(86) PCT No.: PCT/CN2023/101995

§ 371 Date: Jan. 16, 2025

(30) Foreign Application Priority Data
Sep. 22, 2022 (WO) PCT/CN2022/120438

(51) Int. Cl. H04W 74/0833; H04W 16/28; H04W 72/231

(52) U.S. Cl. CPC H04W 74/0833; H04W 16/28; H04W 72/231

(57) ABSTRACT

This disclosure provides systems, methods, and devices for wireless communication that support PRACH repetition suing different beams. In a first aspect, a method of wireless communication includes determining that a first PRACH transmission occasion occurs during a first time period, determining that a second PRACH transmission occasion occurs during a second time period, transmitting a first PRACH transmission at the first PRACH transmission occasion using the first beam based on the determination that the first PRACH transmission occasion occurs during the first time period, and transmitting a second PRACH transmission at the second PRACH transmission occasion using the second beam based on the determination that the second PRACH transmission occasion occurs during the second time period, wherein the second PRACH transmission is a repetition of the first PRACH transmission. Other aspects and features are also claimed and described.

### CROSS-REFERENCE TO RELATED APPLICATIONS

This application claims the benefit of International Patent Application No. PCT/CN2022/120438, entitled, “PRACH REPETITION USING DIFFERENT BEAMS,” filed on Sep. 22, 2022, which is expressly incorporated by reference herein in its entirety.

### TECHNICAL FIELD

Aspects of the present disclosure relate generally to wireless communication systems, and more particularly, to physical random access channel (PRACH) repetition transmissions. Some features may enable and provide improved communications, including use of different beams for PRACH repetition transmissions.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication by a UE includes determining that a first PRACH transmission occasion occurs during a first time period, wherein the first time period is a first time period for which the UE is configured to transmit PRACH transmissions using a first beam, determining that a second PRACH transmission occasion occurs during a second time period, wherein the second time period is a second time period for which the UE is configured to transmit PRACH transmissions using a second beam, different from the first beam, transmitting a first PRACH transmission at the first PRACH transmission occasion using the first beam based on the determination that the first PRACH transmission occasion occurs during the first time period, and transmitting a second PRACH transmission at the second PRACH transmission occasion using the second beam based on the determination that the second PRACH transmission occasion occurs during the second time period, wherein the second PRACH transmission is a repetition of the first PRACH transmission.

In an additional aspect of the disclosure, an apparatus, such as a UE, includes at least one processor and a memory coupled to the at least one processor. The at least one processor is configured to determine that a first PRACH transmission occasion occurs during a first time period, wherein the first time period is a first time period for which the apparatus is configured to transmit PRACH transmissions using a first beam, determine that a second PRACH transmission occasion occurs during a second time period, wherein the second time period is a second time period for which the apparatus is configured to transmit PRACH transmissions using a second beam, transmit a first PRACH transmission at the first PRACH transmission occasion using the first beam based on the determination that the first PRACH transmission occasion occurs during the first time period, and transmit a second PRACH transmission at the second PRACH transmission occasion using the second beam based on the determination that the second PRACH transmission occasion occurs during the second time period, wherein the second PRACH transmission is a repetition of the first PRACH transmission.

In an additional aspect of the disclosure, an apparatus, such as a UE, includes means for determining that a first PRACH transmission occasion occurs during a first time period, wherein the first time period is a first time period for which the apparatus is configured to transmit PRACH transmissions using a first beam, a means for determining that a second PRACH transmission occasion occurs during a second time period, wherein the second time period is a second time period for which the apparatus is configured to transmit PRACH transmissions using a second beam, different from the first beam, a means for transmitting a first PRACH transmission at the first PRACH transmission occasion using the first beam based on the determination that the first PRACH transmission occasion occurs during the first time period, and a means for transmitting a second PRACH transmission at the second PRACH transmission occasion using the second beam based on the determination that the second PRACH transmission occasion occurs during the second time period, wherein the second PRACH transmission is a repetition of the first PRACH transmission.

In an additional aspect of the disclosure, a method for wireless communication by a first network node, such as a base station, includes determining a coherence time for a UE based on one or more transmission parameters of the UE, transmitting an indication of the coherence time to the UE, and receiving a first PRACH transmission from the UE using a first beam at a first PRACH transmission occasion, after transmitting the indication of the coherence time.

In an additional aspect of the disclosure, an apparatus, such as a first network node, includes at least one processor and a memory coupled to the at least one processor. The at least one processor is configured to determine a coherence time for a UE based on one or more transmission parameters of the UE, transmit an indication of the coherence time to the UE, and receive a first PRACH transmission from the UE using a first beam at a first PRACH transmission occasion after transmitting the indication of the coherence time.

In an additional aspect of the disclosure, an apparatus, such as a first network node, includes a means for determining a coherence time for a UE based on one or more transmission parameters of the UE, a means for transmitting an indication of the coherence time to the UE, and a means for receiving a first PRACH transmission from the UE using a first beam at a first PRACH transmission occasion, after transmitting an indication of the coherence time.

In an additional aspect of the disclosure, a non-transitory computer-readable medium stores instructions that, when executed by a processor, cause the processor to perform the operations described herein.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports PRACH repetition using different beams according to one or more aspects.

FIG. 4 is a timing diagram showing PRACH and Msg3 repetition using different beams according to one or more aspects.

FIG. 5 is a flow diagram illustrating an example process that supports PRACH repetition using different beams according to one or more aspects.

FIG. 6 is a flow diagram illustrating an example process that supports PRACH repetition using different beams according to one or more aspects.

FIG. 7 is a flow diagram illustrating an example process that supports PRACH repetition using different beams according to one or more aspects.

FIG. 8 is a block diagram of an example base station that supports PRACH repetition using different beams according to one or more aspects.

FIG. 9 is a block diagram of an example UE that supports PRACH repetition using different beams according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

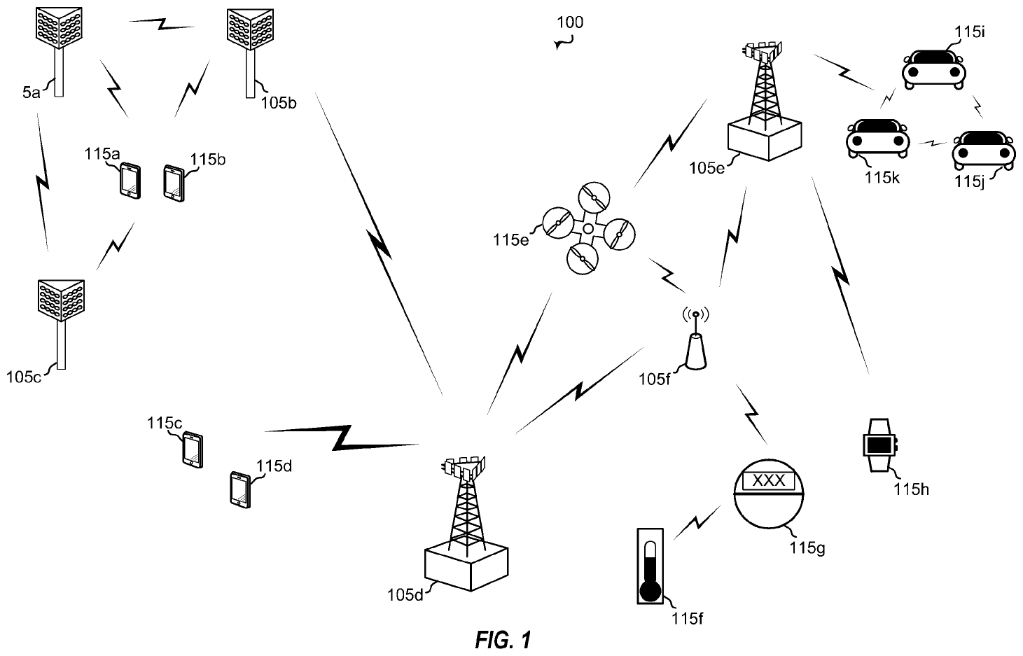

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105c, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

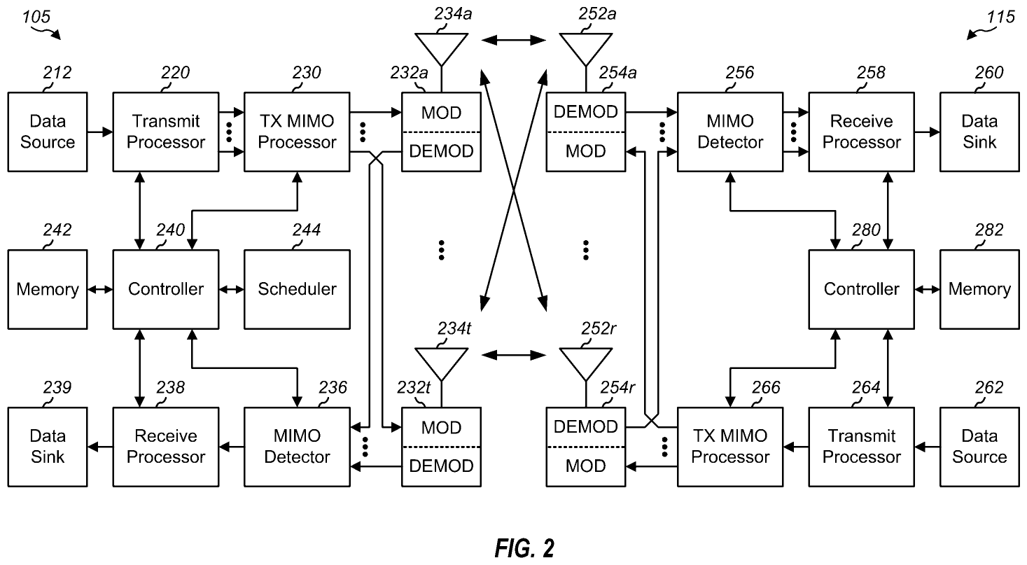

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

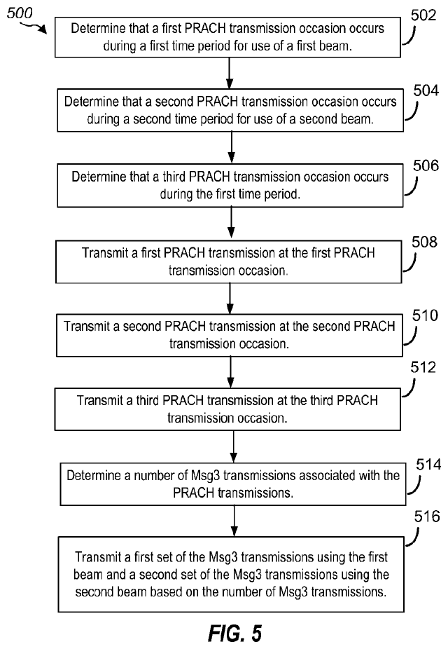

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 5-7, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

A UEs may transmit physical random access channel (PRACH) transmissions, such as random access preambles, to one or more network nodes, such as one or more base stations, to synchronize uplink transmissions between respective UEs and network nodes. PRACH transmissions may be repeated one or more times to provide greater reliability in reception. For example, a PRACH transmission may be repeated two, three, four, or more times. PRACH transmissions including the first PRACH transmission and one or more repetitions of the first PRACH transmission may be transmitted using different beams to provide greater reliability in reception, reduced interference, and reduced energy usage.

PRACH transmissions may be used to synchronize an uplink transmission. For example, in a contention-based random access channel (RACH) procedure, such as a four-step RACH procedure, a base station receiving one or more of the PRACH transmissions, such as one or more random access preambles or message one (Msg1) transmissions from a UE, may respond to receipt of a PRACH transmission by transmitting a message two (Msg2) response to the PRACH transmission to the transmitting UE. The Msg2 response may include a resource allocation for the UE to use in transmitting information to the base station. Upon receipt of the Msg2 response, the UE may transmit a one or more Msg3 repetitions to the base station based on receipt of the Msg2 response. Thus, repeated PRACH transmissions may allow a UE to synchronize with a base station for transmission of a scheduled UL transmission, such as a Msg3 transmission.

A UE may use different beams for transmission of a set of PRACH transmissions including a first PRACH transmission and one or more repetitions of the first PRACH transmission and a set of Msg3 transmissions including a first Msg3 transmission and one or more repetitions of the first Msg3 transmission. For example a UE may use a first beam for transmission of a first PRACH transmission and a second PRACH transmission, where the second PRACH transmission is a repetition of the first PRACH transmission. The UE may use a second beam, different from the first beam, for transmission of a third PRACH transmission and a fourth PRACH transmission, where third and fourth PRACH transmissions are repetitions of the first PRACH transmission. The first, second, third, and fourth PRACH transmissions may, for example, be a set of PRACH transmissions.

Use of different beams for transmission of sets of repeating PRACH transmissions and repeating Msg3 transmissions may enhance reliability. For example, a first beam for transmitting a first set of PRACH transmissions may have a first beam direction, while a second beam for transmitting a second set of PRACH transmissions may have a second beam direction. The first beam having the first beam direction may, for example, have a first transmit control information (TCI) state or quasi-collocation (QCL) state, while the second beam having the second beam direction may have a second TCI state or QCL state different from the first TCI state or QCL state. Use of different beams may include use of different uplink spatial filtering configurations for PRACH transmissions and Msg3 transmissions.

In determining which PRACH transmissions should be transmitted using the same beams, a UE may use time periods for transmission of PRACH transmissions using certain beams. For example, a UE may be configured to transmit a set of PRACH transmissions including a first PRACH transmission and one or more repetitions of the first PRACH transmission at a plurality of PRACH transmission occasions. The UE may determine that one or more PRACH transmission occasions for transmission of a PRACH transmission and repetitions of the PRACH transmission occur during a first time period, where the first time period is a first time period for which the UE is configured to transmit PRACH transmissions using a first beam. For example, the first time period may be a first time period for use of a first beam for transmission of PRACH transmissions at PRACH occasions during the first time period. The UE may further determine that one or more PRACH transmission occasions for transmission of repetitions of the first PRACH transmission occur during a second time period, where the second time period is a second time period for which the UE is configured to transmit PRACH transmissions using a second beam, different from the first beam. For example, the second time period may be a second time period for use of a second beam for transmission of PRACH transmissions at PRACH occasions during the second time period. The PRACH transmission occasions that occur in a time period may be referred to as a PRACH transmission occasion bundle and may all be transmitted using the same beam. Thus, for example, if two PRACH transmission occasions occur during a first time period for transmission of PRACH transmissions using a first beam and two PRACH transmission occasions occur during a second time period for transmission of PRACH transmissions using a second beam, the PRACH transmissions at the PRACH transmission occasions may be transmitted using the respective beams associated with the respective time periods. In some embodiments, such time periods may be determined for transmission of PRACH transmissions in four-step RACH procedures or other RACH procedures. In some embodiments, such time periods may be determined for transmission of PRACH transmissions using a FR2 frequency band, such as a 60 kHz to 120 KHz frequency band, or a FR1 frequency band, such as a 15 kHz to 30 KHz frequency band. Furthermore, such time periods may be determined for transmission of PRACH transmissions using PRACH format B4, short physical uplink control channel PRACH formats, and other PRACH formats.

A coherence time may be used to determine time periods for use of specific beams in transmitting PRACH transmissions. A coherence time may be a duration of time during which a PRACH transmission and repetitions of the PRACH transmission should be transmitted using the same beam. Use of a coherence time can reduce interference while enhancing reliability in reception of the PRACH transmissions. For example, a coherence time may be determined based on a frequency range of the UE transmitting the PRACH transmissions, a frequency band of the UE transmitting the PRACH transmissions, a PRACH format for the UE transmitting the PRACH transmissions, or a time domain window (TDW) for demodulation reference signal (DMRS) bundling for the UE transmitting the PRACH transmissions. Thus, for example, a UE may determine a coherence time and may determine first, second, and, in some embodiments, additional time periods for use of different beams in transmitting a PRACH transmission and one or more repetitions of the PRACH transmission based on the coherence time. For example, the duration of the first time period, the second time period, and any additional time periods may be equal to a duration of the coherence time. In some embodiments, the first time period may begin at the beginning of transmission of an initial PRACH transmission and the second time period may begin at the end of the first time period. The first time period may thus be a first instance of the coherence time, and the second time period may be a second instance of the coherence time. For example, any PRACH transmissions transmitted at a PRACH occasion that occurs during a first instance of the coherence time may be transmitted using the first beam, and any PRACH transmissions transmitted at a PRACH occasion that occurs during a second instance of the coherence time, immediately following the first instance of the coherence time, may be transmitted using a second beam. In some embodiments, additional instances of the coherence time may correspond to additional sequential time periods for additional beams. Thus, a coherence time for a UE may be used to determine beams for transmission of a PRACH transmission and repetitions of the PRACH transmission.

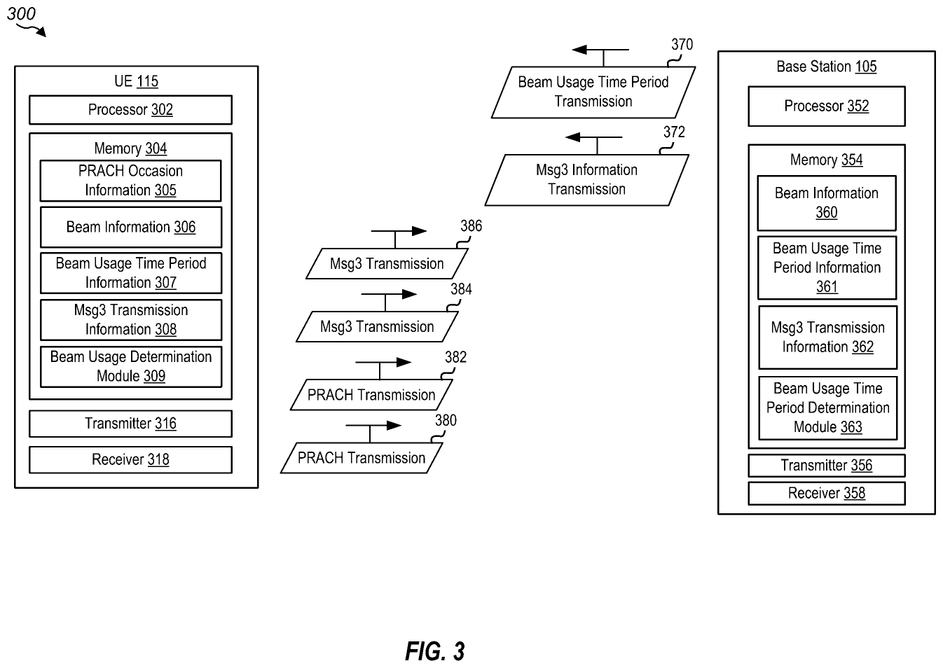

FIG. 3 is a block diagram of an example wireless communications system 300 that supports PRACH repetition using different beams according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store PRACH occasion information 305. PRACH occasion information 305 may, for example, include one or more times of one or more PRACH transmission occasions. For example, PRACH occasion information 305 may include one or more times of one or more PRACH transmission occasions for transmission of a PRACH transmission, such as a random access preamble or Msg1 transmission, and one or more repetitions of the PRACH transmission. Memory 304 includes or is configured to store beam information 306. Beam information 306 may, for example, include information regarding one or more beams to be used in transmitting a PRACH transmission, one or more repetitions of the PRACH transmission, a Msg3 transmission, or one or more repetitions of the Msg3 transmission. The beam information 306 may, for example, include information regarding directions of one or more beams, such as TCI state information for one or more beams, QCL state information for one or more beams, uplink spatial filtering configurations for one or more beams, or other information for one or more beams. Memory 304 includes or is configured to include beam usage time period information 307. Beam usage time period information 307 may, for example, include one or more time periods for usage of one or more beams for transmission of PRACH transmissions. For example, beam usage time period information 307 may include a first time period for transmission of PRACH transmissions using a first beam and a second time period for transmission of PRACH transmissions using a second beam. Beam usage time period information 307 may, for example, include information regarding particular PRACH transmission occasions that occur during particular time periods for usage of particular beams for PRACH transmissions. Beam usage time period information 307 may also include one or more coherence times for the UE 115, such as one or more coherence times determined by the UE 115 or the base station 105. Memory 304 includes or is configured to include Msg3 transmission information 308. Msg3 transmission information 308 may include a number of Msg3 transmissions, such as a number of Msg 3 transmissions including a first Msg3 transmission and one or more repetitions of the Msg3 transmission, to be transmitted by the UE 115 and timing information for the Msg3 transmissions. Msg3 transmission information 308 may include scheduling information for Msg3 transmissions to be transmitted by the UE 115 received from the base station 105 in a Msg2 transmission. Memory 304 includes or is configured to include a beam usage determination module 309. The beam usage determination module 309 may include instructions for determining time periods for usage of different beams for transmission of PRACH transmissions, such as a PRACH transmission and one or more repetitions of the PRACH transmission. Such instructions may, for example, include instructions for determination of time periods for usage of different beams based on a coherence time. The beam usage determination module 309 may further include instructions for determining which PRACH transmission occasions for transmission of a PRACH transmission and repetitions of the PRACH transmission occur during specific time periods and therefore which beams should be used for transmission of PRACH transmissions at particular PRACH transmission occasions. The beam usage determination module 309 may further include instructions for determining one or more beams for usage in transmission of one or more Msg3 transmissions, such as a Msg3 transmission and one or more repetitions of the Msg3 transmission. Such instructions may, for example, include instructions for determining one or more beams for usage in transmission of one or more Msg3 transmissions based on a total number of Msg3 transmissions, including a Msg3 transmission and one or more repetitions of the Msg3 transmission, that will be transmitted in response to one or more PRACH transmissions.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store beam information 360. Beam information 360 may include information regarding one or more beams on which a UE 115 will transmit PRACH transmissions, such as random access preamble or Msg1 transmissions, to the base station 105 or information regarding one or more beams on which the UE 115 will transmit one or more Msg3 transmissions to the base station 105. Memory 354 includes or is configured to store beam usage time period information 361. Beam usage time period information 361 may include information about one or more time periods for use of different beams for transmission of PRACH transmissions by the UE 115. Beam usage time period information 361 may include one or more coherence times for the UE 115. Beam usage time period information 361 may include information for use by the beam usage time period determination module 363 in determining beam usage time periods or coherence times, such as a frequency range for the UE 115, a frequency band for the UE 115, a PRACH format used by the UE 115 for transmitting PRACH transmissions, or a TDW for DMRS bundling for the UE 115. Memory 354 includes or is configured to store Msg3 transmission information 362. Msg3 transmission information 362 may, for example, include information regarding a number of Msg3 transmissions, such as a Msg3 transmission and one or more repetitions of the Msg3 transmission, to be transmitted by the UE 115 in response to a Msg2 transmission by the base station 105. Memory 354 includes or is configured to include a beam usage time period determination module 363. The beam usage time period determination module 363 may, for example, include instructions for determining time periods for the UE 115 to use particular beams for transmission of PRACH transmissions. For example, the beam usage time period determination module 363 may include instructions for determining a first time period for use of a first beam for PRACH transmissions, a second time period for use of a second beam for PRACH transmissions, and, in some embodiments, additional time periods for use of additional beams for PRACH transmissions. Such time periods may be time periods for which the UE is configured to use respective beams for transmission of PRACH transmissions. In some embodiments, the beam usage time period determination module 363 may include instructions for determining one or more coherence times for the UE 115. In some embodiments, the beam usage time period determination module 363 may include instructions for determining a coherence time for the UE based on a frequency range for the UE 115, a frequency band for the UE 115, a PRACH format used by the UE 115 for transmitting PRACH transmissions, or a TDW for DMRS bundling for the UE 115.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, the base station 105 may transmit a beam usage time period transmission 370 to the UE 115. The beam usage time period transmission 370 may include beam usage time period information 361. For example, the base station 105 may determine a coherence time for the UE 115 and may transmit an indication of the coherence time in the beam usage time period transmission 370. The beam usage time period transmission 370 may be a system information block one (SIB1) transmission or a radio resource control (RRC) transmission. The base station 105 may also transmit a Msg3 transmission 372, which may include Msg3 transmission information 662. The Msg3 transmission 372 may, for example, include scheduling information for one or more Msg3 transmissions to be transmitted in response to the Msg3 information transmission 372 or may include a number of Msg3 transmissions, such as a number of a Msg3 transmission and one or more repetitions of the Msg3 transmission, to be transmitted in response to the Msg3 information transmission 372. The Msg3 information transmission 372 may, for example, be a Msg2 transmission transmitted by the base station 105 in response to receipt of one or more PRACH transmissions, such as one or more random access preamble or Msg1 transmissions, from the UE 115.

The UE 115 may transmit a first PRACH transmission 380 using a first beam at a first PRACH occasion in a first time period for use of the first beam based on the beam usage time period information 307. Thus, the UE 115 may be configured to use a first beam for transmission of PRACH transmissions that are transmitted during the first time period. The UE 115 may transmit a second PRACH transmission 382 using a second beam at a second PRACH occasion in a second time period for use of the second beam based on the beam usage time period information 307. Thus, the UE 115 may be configured to use a second beam, different from the first beam, for transmission of PRACH transmissions that are transmitted during the second time period. Configuration of the UE to transmit PRACH transmissions in the first and second time periods using the first and second beams may, for example, be performed based on beam usage time period information received by the UE 115 from the base station 105 in the beam usage time period transmission 370. For example, the UE 115 may determine that a first PRACH transmission occasion for transmitting a first PRACH transmission 380 occurs during a first time period for use of a first beam, and may transmit the first PRACH transmission 380 using the first beam. Likewise, the UE 115 may determine that a second PRACH transmission occasion for transmitting a second PRACH transmission 382 occurs during a second time period for use of a second beam, and may transmit the second PRACH transmission 382 using the second beam. The second PRACH transmission 382 may be a repetition of the first PRACH transmission 380. In some embodiments, the UE 115 may determine that the second PRACH transmission 382 is to be transmitted at a second PRACH transmission occasion that is during the first time period for use of the first beam and may transmit the second PRACH transmission 382 at the second PRACH transmission occasion using the first beam. The UE may further transmit a first Msg3 transmission 384 and a second Msg3 transmission 386. The first Msg3 transmission 384 may be transmitted using the first beam, and the second Msg3 transmission 386 may be transmitted using the second beam. The second Msg3 transmission 386 may, for example, be a repetition of the first Msg3 transmission 384. The UE 115 may determine to transmit the first Msg3 transmission 384 using the first beam and the second Msg3 transmission 386 using the second beam based on Msg3 information received in the Msg3 information transmission 372, the usage of the first beam for transmission of the first PRACH transmission 380, and the usage of the second beam for transmission of the second PRACH transmission 382.

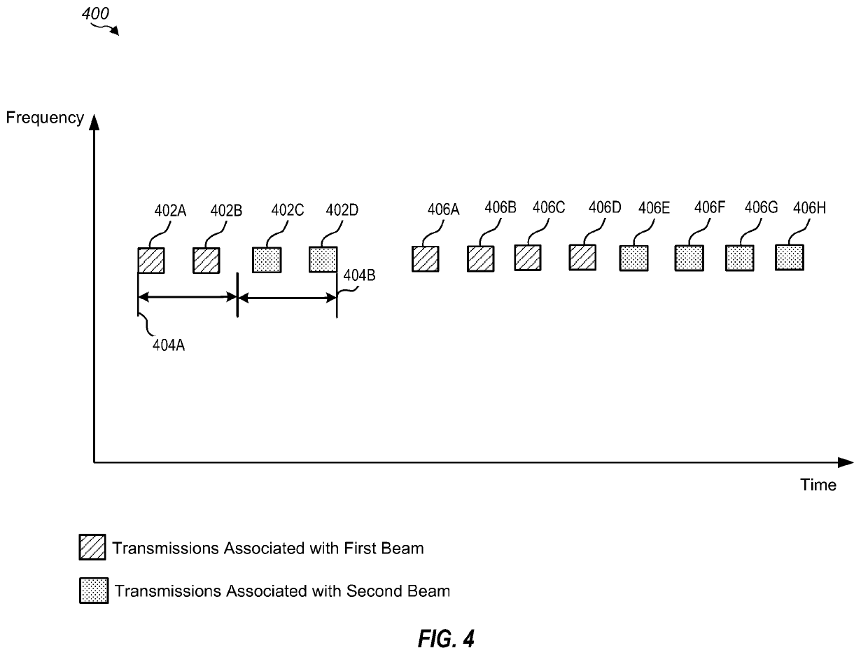

As discussed herein, a UE may be configured to transmit multiple PRACH transmissions, such as a first PRACH transmission and one or more repetitions of the first PRACH transmission, using multiple different beams. The UE may determine which beam to use for each PRACH transmission based on time periods in which the PRACH transmission occasions at which the PRACH transmissions are to be transmitted occur. In some embodiments, such time periods may be determined based on a coherence time, and each time period may have a duration equal to a duration of the coherence time. Furthermore, subsequent Msg3 transmissions associated with the PRACH transmissions may be transmitted using the same beams, based on usage of the beams for transmitting PRACH transmissions. An example time/frequency plot 400 of multiple PRACH transmissions 402A-D and Msg3 transmissions 406A-H is shown in FIG. 4.

A UE may transmit a first PRACH transmission 402A and a second PRACH transmission 402B using a first beam. The UE may determine to use the first beam for transmission of the first PRACH transmission 402A and the second PRACH transmission 402B based on PRACH transmission occasions at which the first PRACH transmission 402A and the second PRACH transmission 402B are transmitted being within a first time period 404A. The UE may further transmit a third PRACH transmission 402C and a fourth PRACH transmission 402D using a second beam. The UE may determine to use the second beam for transmission of the third PRACH transmission 402C and the fourth PRACH transmission 402D based on PRACH transmission occasions at which the third PRACH transmission 402C and the fourth PRACH transmission 402D are transmitted being within a second time period 404B. The second PRACH transmission 402B, the third PRACH transmission 402C, and the fourth PRACH transmission 402D may be repetitions of the first PRACH transmission 402A, including the same or similar information. The first time period 404A may, for example, be a first time period 404A for use of a first beam for PRACH transmissions, such as a first time period for which the UE is configured to transmit PRACH transmissions using the first beam, and the second time period 404B may be a second time period 404B for use of a second beam for PRACH transmissions, such as a second time period for which the UE is configured to transmit PRACH transmissions using the second beam. The UE may determine the first time period 404A and the second time period 404B based on a coherence time. For example, the coherence time may specify a time duration for the UE for use of a same beam for PRACH transmissions. Durations of the first time period 404A and the second time period 404B may be equal to a duration of the coherence time. The second time period 404B may begin at an end of the first time period 404A. The first time period 404A may begin at a beginning of a PRACH occasion for transmission of a first PRACH transmission 402A, to be followed by one or more repetitions of the first PRACH transmission 402A. In some embodiments, one, two, or more PRACH transmission occasions for PRACH transmissions may occur in a single time period for use of a first beam. In some embodiments, fewer than or more than three repetitions of the same PRACH transmission may be transmitted. In some embodiments, more than two beams may be used for PRACH transmissions. For example, an additional time period may include one or more PRACH transmission occasions for transmission of PRACH transmissions using an additional beam. PRACH transmissions transmitted using a same beam and including the same or similar information, such as PRACH transmissions 402A and 402B or PRACH transmissions 402C and 402D may be referred to as PRACH transmission bundles. Thus, a set of PRACH transmissions including a first PRACH transmission and one or more repetitions of the first PRACH transmission may be transmitted using a plurality of beams based on time periods in which the PRACH transmissions are transmitted.

The same beams used for transmission of PRACH transmissions may be used for transmission of a set of Msg3 transmissions 406A-H including a first Msg3 transmission 406A, and a plurality of repetitions 406B-H of the first Msg3 repetition. The Msg3 transmissions 406A-H may, for example, be Msg3 transmissions associated with the PRACH transmissions 402A-D, such as Msg3 transmissions transmitted by the UE in response to a Msg2 transmission received from a base station in response to one or more of the PRACH transmissions 402A-D. For example, Msg3 transmissions 406A-D may be transmitted using the first beam, and Msg3 transmissions 406E-H may be transmitted using the second beam. Msg3 transmissions 406B-H may be repetitions of Msg3 transmission 406A and may include the same or similar information. The UE may determine which Msg3 transmissions of a set of Msg3 transmissions 406A-H to transmit using a particular beam based on a total number of Msg3 transmissions to be transmitted associated with one or more PRACH transmissions, such as a first PRACH transmission and one or more repetitions of the first PRACH transmission, including the first Msg3 transmission 406A and one or more repetitions 406B-H of the first Msg3 transmission 406A, and based on the beams used for transmission of PRACH transmissions 402A-D associated with the Msg3 transmissions 406A-H. For example, if two beams are used for transmissions of a set of PRACH transmissions, including a first PRACH transmission and one or more repetitions of the first PRACH transmission, and the UE is scheduled to transmit eight Msg3 transmissions associated with the PRACH transmissions, the UE may transmit a first set of the Msg3 transmissions 406A-D using the first beam and a second set of the Msg3 transmissions 406E-H using the second beam. Thus, a number of Msg3 transmissions transmitted using a particular beam may be equal to the total number of Msg3 transmissions associated with the PRACH transmissions divided by the number of beams used for transmission of the PRACH transmission and the one or more repetitions of the PRACH transmission.

In some embodiments, the UE may be configured to transmit a number of Msg3 transmissions 406A-H associated with the PRACH transmissions 402A-D that is divisible by the number of beams used for transmission of the associated PRACH transmissions, in order to transmit the same number of Msg3 transmissions using each respective beam. As another example, if a total number of Msg3 transmissions is six and three beams are used for transmission of associated PRACH transmissions, the UE may transmit two Msg3 transmissions using each of the beams. Although shown as being transmitted on the same frequency resources, in some embodiments PRACH transmissions 402A-D and Msg3 transmissions 406A-H may be transmitted on different frequency resources. Thus, a UE may use multiple different beams for transmission of PRACH transmissions and the same beams for transmission of associated Msg3 transmissions.

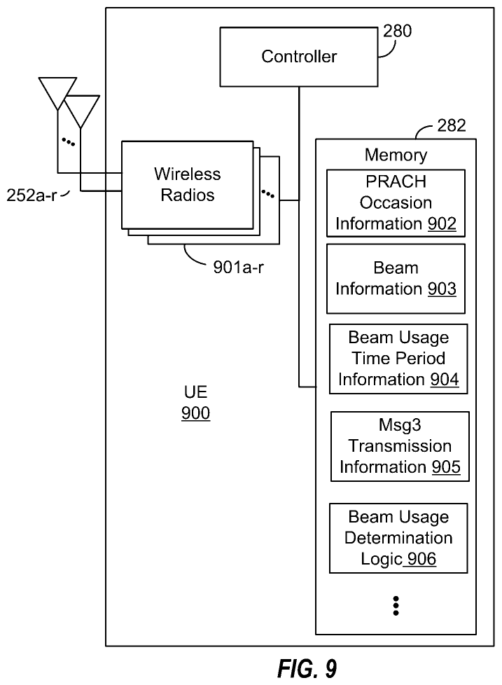

FIG. 5 is a flow diagram illustrating an example process 500 that supports PRACH repetition using different beams according to one or more aspects. Operations of process 500 may be performed by a UE, such as UE 115 described above with reference to FIG. 1, 2, or 3, or a UE described with reference to FIG. 9. For example, example operations (also referred to as “blocks”) of process 500 may enable UE 115 to support PRACH repetition using different beams.

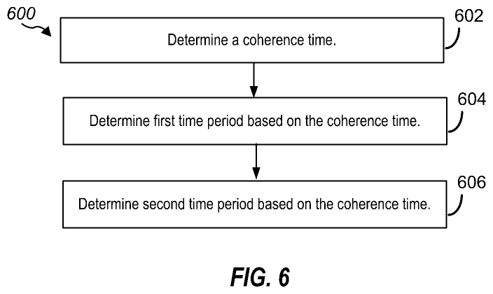

A UE may determine beams for transmission of multiple PRACH transmissions, such as a first PRACH transmission and one or more repetitions of the first PRACH transmission, based on time periods in which PRACH transmission opportunities at which the PRACH transmissions are transmitted occur. Such time periods may, for example, be determined based on a coherence time. At block 502, a UE may determine that a first PRACH transmission occasion occurs during a first time period for use of a first beam for transmission of PRACH transmissions. The first time period may be a first time period for which the UE is configured to transmit PRACH transmissions using the first beam. For example, a UE may determine to transmit a first PRACH transmission and one or more repetitions of the first PRACH transmission. The UE may determine that the first PRACH transmission will be transmitted at a first PRACH occasion that occurs during a first time period. The first time period may be determined based on a coherence time, as described with respect to the process 600 of FIG. 6. The first PRACH transmission occasion may be a transmission occasion for an initial PRACH transmission that will be followed by one or more repetitions of the first PRACH transmission. Thus, the first time period may, in some embodiments, begin at a beginning of the first PRACH transmission occasion.

At block 504, the UE may determine that a second PRACH transmission occasion occurs during a second time period for use of a second beam. The second beam may be different from the first beam. The second time period may be a time period for which the UE is configured to transmit PRACH transmissions using the second beam. The second PRACH transmission occasion may be a PRACH transmission occasion for transmission of a repetition of the first PRACH transmission including the same or similar information. For example, the UE may determine to transmit a second PRACH transmission that is a repetition of a first PRACH transmission, the first PRACH transmission to be transmitted at a first PRACH transmission occasion, at a second PRACH transmission occasion that occurs within a second time period. The second time period may be subsequent to the first time period. In some embodiments, the second time period may be equal in duration to the first time period. In some embodiments, the second time period may begin at an end of the first time period. In some embodiments, the UE may determine that additional PRACH transmission occasions for transmission of additional repetitions of a first PRACH transmission occur within additional time periods for use of additional different beams, such as additional time periods for which the UE is configured to transmit PRACH transmissions using additional different beams. In some embodiments, the time periods for use of beams for PRACH transmissions do not overlap.

At block 506, the UE may determine that a third PRACH transmission occasion occurs during the first time period for use of the first beam. The third PRACH transmission occasion may be a PRACH transmission occasion for transmission of a repetition of the first PRACH transmission including the same or similar information. For example, the UE may determine to transmit a third PRACH transmission that is a repetition of a first PRACH transmission, the first PRACH transmission to be transmitted at a first PRACH transmission occasion in a first time period, at a third PRACH transmission occasion that occurs within the first time period. Thus, because the third PRACH transmission occurs within the first time period for use of the first beam, the first beam may also be used for transmission of the third PRACH transmission. In some embodiments, the UE may determine that additional PRACH transmission occasions for additional repetitions of the first PRACH transmission occur during the first time period, the second time period, or additional time periods. Thus, the UE may determine that PRACH transmission occasions for a PRACH transmission and one or more repetitions of the PRACH transmission occur within particular time periods for use of particular beams. The third PRACH transmission occasion and the first PRACH transmission occasion, and any other PRACH transmission occasions for repetitions of the first PRACH transmission that occur during the first time period, may form a first RACH opportunity bundle.

At block 508, the UE may transmit a first PRACH transmission at the first PRACH occasion using the first beam. For example, because the first PRACH transmission is transmitted at a first PRACH occasion that occurs during a first time period for use of a first beam, such as a first time period for which the UE is configured to transmit PRACH transmissions using the first beam, the UE may transmit the first PRACH transmission using the first beam. The first PRACH transmission may, for example, be a random access preamble, such as a Msg1 transmission.

At block 510, the UE may transmit a second PRACH transmission at the second PRACH occasion using the second beam. For example, because the second PRACH transmission is transmitted at a second PRACH occasion that occurs during a second time period for use of a second beam, such as a second time period for which the UE is configured to transmit PRACH transmissions using a second beam, the UE may transmit the second PRACH transmission using the second beam. The second PRACH transmission may, for example, be a repetition of the first PRACH transmission including the same or similar information.

At block 512, the UE may transmit a third PRACH transmission at the third PRACH occasion using the first beam. For example, because the third PRACH transmission is transmitted at a third PRACH occasion that occurs during the first time period for use of the first beam, the UE may transmit the third PRACH transmission using the first beam. Thus, the third PRACH transmission may be transmitted using the same beam as the first transmission because the PRACH transmission occasions at which the first PRACH transmission and the third PRACH transmission are transmitted occur during the first time period. The third PRACH transmission may, for example, be a repetition of the first PRACH transmission including the same or similar content.

The UE may transmit Msg3 transmissions associated with the PRACH transmissions, such as a first Msg3 repetition and one or more repetitions of the first Msg3 transmission, using the same beams used for transmission of the PRACH transmissions. At block 514, the UE may determine a number of Msg3 transmissions associated with the PRACH transmissions, such as associated with the first PRACH transmission, the second PRACH transmission, or the third PRACH transmission. For example, as described with respect to blocks 508-512, the UE may transmit a PRACH transmission and one or more repetitions of the PRACH transmission. One or more of the PRACH transmission and repetitions may be received by a base station. The base station may transmit a response, such as a Msg3 information transmission. The Msg3 information transmission may, for example, be a transmission that includes information for scheduling the sets of Msg3 transmissions, such as a Msg2 transmission. For example, the Msg3 information transmission may include a total number of Msg3 transmissions, such as a total number of a first Msg3 transmission and one or more repetitions of the first Msg3 transmission, associated with the PRACH transmissions to be transmitted by the UE. For example, determining the number of Msg3 transmissions associated with the PRACH transmissions may include receiving the number in a Msg2 transmission from a base station or receiving the number in a downlink control information (DCI) transmission from the base station, such as a DCI transmission for scheduling the Msg3 transmissions. Msg3 transmissions that are associated with PRACH transmissions may, for example, be a Msg3 transmission and one or more repetitions of the Msg3 transmission that are scheduled by a base station in response to receipt of one or more of a PRACH transmission and one or more repetitions of the PRACH transmission by the base station. Thus, the Msg3 transmissions may be associated with the first, second, or third PRACH transmissions because they may be scheduled by a base station in response to receipt of the first, second, or third PRACH transmissions, or other PRACH transmissions that are repetitions of the first PRACH transmission.

At block 516, the UE may transmit a first set of the Msg3 transmissions using the first beam and a second set of the Msg3 transmissions using the second beam based on the number of Msg3 transmissions. For example, the UE may transmit a first set of the Msg3 transmissions using the first beam based on the number of Msg3 transmissions and based on transmission of the first PRACH transmission using the first beam. The UE may transmit a second set of the Msg3 transmissions using the second beam based on the number of Msg3 transmissions and based on transmission of the second PRACH transmission using the second beam. In some embodiments, the first set of Msg3 transmissions may include one or more Msg3 transmissions and the second set of Msg3 transmissions may include one or more Msg3 transmissions. For example, the first set of Msg3 transmissions may include a first Msg3 transmission and one or more repetitions of the first Msg3 transmission, and the second set of Msg3 transmissions may include one or more repetitions of the first Msg3 transmission. Msg3 transmissions may, for example, be scheduled uplink transmissions transmitted by the UE. Transmission of the first set of Msg3 transmissions using the first beam based on the number of Msg3 transmissions and transmission of the first PRACH transmission using the first beam and transmission of the second set of Msg3 transmissions using the second beam based on the number of Msg3 transmissions and transmission of the second PRACH transmission using the second beam may be based on a total number of beams used to transmit the first PRACH transmission and repetitions of the first PRACH transmission. For example, the UE may determine a total number of beams used to transmit the first PRACH transmission and the repetitions of the first PRACH transmission and may divide the number of Msg3 transmissions by the number of beams. Then, the UE may transmit a number of consecutive Msg3 transmissions equal to the quotient of the number of beams used for PRACH transmissions and the number of Msg3 transmissions, using each of the beams. In some embodiments, the UE may be configured to transmit a number of Msg3 transmissions that is divisible by the number of beams used for the PRACH transmissions. Thus, for example, if the UE transmitted a PRACH transmission and repetitions of the PRACH transmission using three beams and the total number of Msg3 transmissions to be transmitted by the UE is nine, the UE may transmit a first set of three Msg3 transmissions using the first beam, a second set of three Msg3 transmissions using the second beam, and a third set of three Msg3 transmissions using the third beam. Other combinations of a number of Msg3 transmissions and a number of PRACH transmissions may also be used. Thus, a UE may transmit Msg3 transmissions using particular beams based on beams used for transmission of associated PRACH transmissions and a total number of Msg3 transmissions to be transmitted.

FIG. 6 is a flow diagram illustrating an example process 600 that supports PRACH repetition using different beams according to one or more aspects. Operations of process 600 may be performed by a UE, such as UE 115 described above with reference to FIGS. 1, 2, 3, or a UE described with reference to FIG. 9. For example, example operations (also referred to as “blocks”) of process 600 may enable UE 115 to support PRACH repetition using different beams.

At block 602, a UE may determine a coherence time. The coherence time may, for example, be a duration of a time period during which a PRACH transmission and repetitions of the PRACH transmission should be transmitted using a same beam. In some embodiments, the UE may determine the coherence time by receiving an indication of the coherence time from a base station, such as by receiving an indication of the coherence time from a base station in a system information block one (SIB1) transmission or other system information (OSI) transmission from the base station. In some embodiments, such as when the UE is configured in a radio resource control (RRC) connected mode, the UE may receive an indication of the coherence time in an RRC transmission from a base station, such as for a contention-free random access PRACH procedure. In some embodiments, the UE may determine the coherence time based on a frequency range of the UE, a frequency band of the UE, a PRACH format of the UE, such as a PRACH format for transmitting the first PRACH transmission and any repetitions of the first PRACH transmission. In some embodiments, such as when the UE is configured in an RRC connected mode, the UE may determine the coherence time based on a TDW for DMRS bundling for unicast physical uplink shared channel (PUSCH) for the UE. Thus, the coherence time may be a duration of time during which all PRACH transmissions should be transmitted using a same beam. In some embodiments, the UE may determine a coherence time by accessing a predefined coherence time stored in a memory of the UE. For example, the coherence time may be a coherence time set by a standard specification and may be stored in a memory of the UE.

At block 604, the UE may determine a first time period based on the coherence time. The first time period may be a first time period for use of a first beam for one or more PRACH transmissions, such as a first time period for which the UE is configured to transmit PRACH transmissions using the first beam. For example, a duration of the first time period described with respect to process 500 of FIG. 5 may be equal to a duration of the coherence time. Thus, the first time period may be determined based on the coherence time. In some embodiments, the first time period may be determined by determining a beginning of the first PRACH transmission occasion described with respect to the process 500 and by establishing an end of the first time period at a point in time where the duration of first time period will be equal to the duration of the coherence time.

At block 606, the UE may determine a second time period based on the coherence time. The second time period may be a second time period for use of a second beam for one or more PRACH transmissions, such as a time period for which the UE is configured to transmit PRACH transmissions using the second beam. For example, a duration of the second time period described with respect to process 500 of FIG. 5 may be equal to a duration of the coherence time. Thus, the second time period may be determined based on the coherence time and may have a duration equal to the duration of the first time period. In some embodiments, the second time period may be determined by determining an end of the first time period described with respect to the process 500 and by establishing an end of the second time period at a point in time where the duration of second time period will be equal to the duration of the coherence time. In some embodiments, the UE may determine additional time periods for use of additional beams in transmitting PRACH transmissions, such as a time period having a duration equal to the coherence time and proceeding from an end of the second time period. In some embodiments, time periods may begin at an end of a previous time period and may have a duration equal to the coherence time. Thus, a UE may determine time periods for use of particular beams for a PRACH transmission and repetitions of the PRACH transmission based on the coherence time.

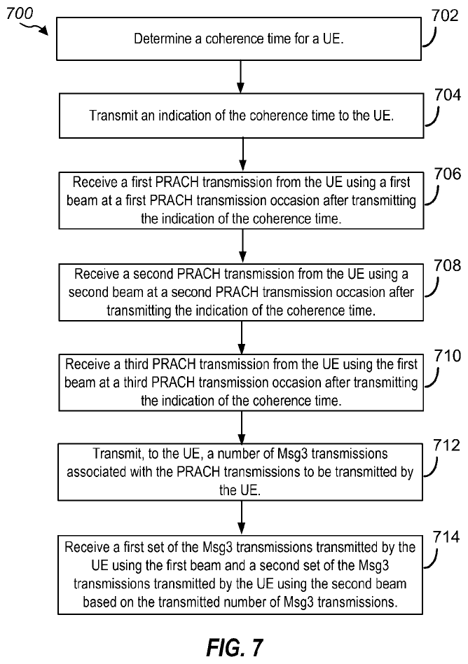

FIG. 7 is a flow diagram illustrating an example process 700 that supports PRACH repetition using different beams according to one or more aspects. Operations of process 700 may be performed by a base station, such as base station 105 described above with reference to FIGS. 1-3 or a base station as described above with reference to FIG. 7. For example, example operations of process 700 may enable base station 105 to support PRACH repetition using different beams.

A base station may determine a coherence time for use by a UE in transmitting one or more PRACH transmissions using different beams. The base station may also determine a number of Msg3 transmissions to be transmitted by the UE following transmission of the one or more PRACH transmissions. For example, the process 700 may be performed by a base station in communication with a UE performing the process 500 of FIG. 5 or the process 600 of FIG. 6. At block 702, the base station may determine a coherence time for a UE. For example, the base station may determine a coherence time for a UE that is in an RRC connected state with the base station or otherwise in communication with the base station. The coherence time may, for example, be a length of a time period during which a PRACH transmission and repetitions of the PRACH transmission should be transmitted by a UE using a same beam. In some embodiments, the base station may determine the coherence time based on one or more transmission parameters of the UE for which the coherence time is being determined, such as a frequency range of the UE, a frequency band of the UE, a PRACH format of the UE, such as a PRACH format for transmitting a first PRACH transmission and any repetitions of the first PRACH transmission. In some embodiments, such as when the UE is configured in an RRC connected mode, the base station may determine the coherence time based on a TDW for DMRS bundling for unicast physical uplink shared channel (PUSCH) for the UE, which may also be a transmission parameter of the UE.

At block 704, the base station may transmit an indication of the coherence time to the UE. For example, the base station may transmit the indication of the coherence time to the UE in a SIB1 transmission or other system information (OSI) transmission. As another example, the base station may transmit the indication of the coherence time to the UE in an RRC transmission, such as for a contention-free random access PRACH procedure when the UE is in an RRC-connected mode with the base station.

At block 706, the base station may receive a first PRACH transmission from the UE using a first beam at a first PRACH transmission occasion after transmitting the indication of the coherence time. In some embodiments, the base station may receive a first PRACH transmission from the UE using the first beam at the first PRACH transmission occasion based on the indication of the coherence time. For example, the UE may determine a plurality of time periods for use of different beams for PRACH transmissions, as described with respect to the process 600 and may transmit PRACH transmissions using particular beams based on the determined time periods, as described with respect to the process 500. The first PRACH transmission may, for example, be the first PRACH transmission described with respect to block 508 of the process 500. Thus, for example, the first PRACH transmission received from the UE may be transmitted by the UE using the first beam at a first PRACH transmission occasion based on a determination by the UE that the first PRACH transmission occasion occurs during a first time period, and the first time period may be determined by the UE based on the coherence time.

At block 708, the base station may receive a second PRACH transmission from the UE using a second beam at a second PRACH transmission occasion after transmitting the indication of the coherence time. In some embodiments, the base station may receive a second PRACH transmission from the UE using a second beam at a second PRACH transmission occasion based on the coherence time. The second PRACH transmission received from the UE may be transmitted by the UE using the second beam at a second PRACH transmission occasion based on a determination by the UE that the second PRACH transmission occasion occurs during a second time period, and the second time period may be determined by the UE based on the coherence time.

At block 710, the base station may receive a third PRACH transmission from the UE using a third beam at a third PRACH transmission occasion after transmission of the indication of the coherence time. In some embodiments, the base station may receive a third PRACH transmission from the UE using the first beam at a third PRACH transmission occasion based on the coherence time. The third PRACH transmission received from the UE may be transmitted by the UE using the first beam at a third PRACH transmission occasion based on a determination by the UE that the third PRACH transmission occasion occurs during the first time period. In some embodiments, the base station may receive only a single PRACH transmission from the UE, such as one of the first, second, or third PRACH transmissions. The second and third PRACH transmissions may, for example, be repetitions of the first PRACH transmission. In some embodiments, the base station may receive additional PRACH transmissions using the same or different beams.

At block 712, the base station may transmit to the UE a number of Msg3 transmissions associated with one or more of the received PRACH transmissions, such as the first PRACH transmission, to be transmitted by the UE. For example, the base station may determine a number of Msg3 transmissions to be transmitted by the UE and may transmit the number to the UE. The base station may also allocate one or more resources for the UE for transmitting PRACH transmissions and may transmit the allocation of PRACH transmissions to the UE. The number of Msg3 transmissions may be transmitted in a Msg2 transmission, transmitted by the base station in response to receipt of one or more of the PRACH transmissions from the UE. The number of Msg3 transmissions may be transmitted in a DCI transmission. The Msg3 transmissions may be associated with the PRACH transmissions in that the number of Msg3 transmissions or a resource allocation for the Msg3 transmissions may be transmitted in response to receipt of one or more of the PRACH transmissions from the UE.

At block 714, the base station may receive a first set of the Msg3 transmissions transmitted by the UE using the first beam and a second set of the Msg3 transmissions transmitted by the UE using the second beam based on the transmitted number of Msg3 transmissions. For example, the first set of the plurality of Msg3 transmissions may be transmitted using the first beam by the UE based on the number of the plurality of Msg3 transmissions and transmission of the first PRACH transmission using the first beam, as described with reference to process 500. The base station may also receive a second set of the Msg3 transmissions transmitted by the UE using the first beam based on the transmitted number of Msg3 transmissions. For example, the second set of the plurality of Msg3 transmissions may be transmitted using the second beam by the UE based on the number of the plurality of Msg3 transmissions and transmission of the second PRACH transmission using the second beam, as described with reference to the process 500. The base station may also receive additional sets of Msg3 transmissions using the same or different beams. In some embodiments, the first set of Msg3 transmissions may include one or more Msg3 transmissions, and the second set of Msg3 transmissions may include one or more Msg3 transmissions. The first set of Msg3 transmissions may include a first Msg3 transmission and one or more repetitions of the first Msg3 transmission, while the second set of Msg3 transmissions may include one or more repetitions of the first Msg3 transmission. A set of Msg3 transmissions transmitted using a same beam may be referred to as a Msg3 transmission bundle or a Msg3 repetition bundle. Thus, a base station may provide a coherence time and a number of Msg3 transmissions to a UE and may receive PRACH transmissions and Msg3 transmissions in response to the indication of the coherence time and the number of Msg3 transmissions, respectively.

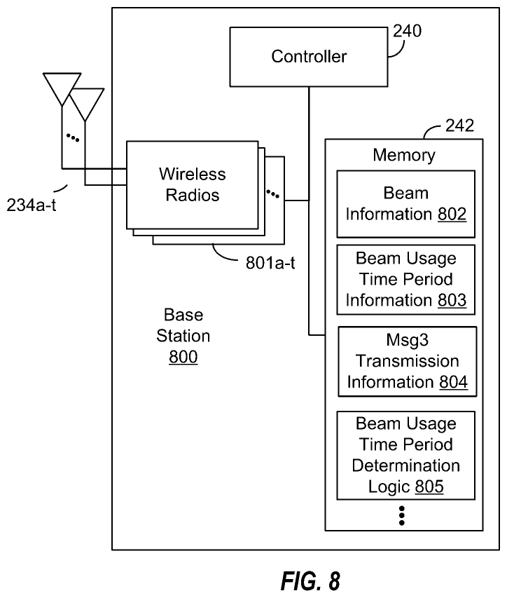

FIG. 8 is a block diagram of an example base station 800 that supports PRACH repetition using different beams according to one or more aspects. Base station 800 may be configured to perform operations, including the blocks of process 700 described with reference to FIG. 7. In some implementations, base station 800 includes the structure, hardware, and components shown and described with reference to base station 105 of FIGS. 1-3. For example, base station 800 may include controller 240, which operates to execute logic or computer instructions stored in memory 242, as well as controlling the components of base station 800 that provide the features and functionality of base station 800. Base station 800, under control of controller 240, transmits and receives signals via wireless radios 801a-t and antennas 234a-t. Wireless radios 801a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include beam information 802, beam usage time period information 803, Msg3 transmission information 804, and beam usage time period determination logic 805. Beam information 802 may include information regarding one or more beams on which a UE 115 will transmit PRACH transmissions, such as random access preamble or Msg1 transmissions, to the base station 105 or information regarding one or more beams on which a UE will transmit one or more Msg3 transmissions to the base station 800. Beam usage time period information 803 one or more time periods for use of different beams for transmission of PRACH transmissions by the UE 115. For example, beam usage time period information 803 may include one or more coherence times. Beam usage time period information 803 may also include information for use by the beam usage time period determination logic 805 in determining beam usage time periods or coherence times, such as a frequency range for a UE, a frequency band for a UE, a PRACH format used by a UE for transmitting PRACH transmissions, or a TDW for DMRS bundling for the UE. Msg3 transmission information 804 may, for example, include information regarding a number of Msg3 transmissions, such as a Msg3 transmission and one or more repetitions of the Msg3 transmission, to be transmitted by a UE in response to a Msg2 transmission by the base station 800. The beam usage time period determination logic 805 may include logic configured to determine time periods for a UE to use particular beams for transmission of PRACH transmissions. For example, the beam usage time period determination logic 805 may be configured to determine a first time period for use of a first beam for PRACH transmissions, such as a first time period for which the UE is configured to transmit PRACH transmissions using a first beam, a second time period for use of a second beam for PRACH transmissions, such as a second time period for which the UE is configured to transmit PRACH transmissions using a second beam, and, in some embodiments, additional time periods for use of additional beams for PRACH transmissions. In some embodiments, the beam usage time period determination logic 805 may include logic configured to determine one or more coherence times for a UE. In some embodiments, the beam usage time period determination logic 805 may include logic configured to determine a coherence time for a UE based on a frequency range for the UE, a frequency band for the UE, a PRACH format used by the UE for transmitting PRACH transmissions, or a TDW for DMRS bundling for the UE. Base station 800 may receive signals from or transmit signals to one or more UEs, such as UE 115 of FIGS. 1-3 or UE 900 of FIG. 9.

FIG. 9 is a block diagram of an example UE 900 that supports PRACH repetition using different beams according to one or more aspects. UE 900 may be configured to perform operations, including the blocks of a process described with reference to FIGS. 5-6. In some implementations, UE 900 includes the structure, hardware, and components shown and described with reference to UE 115 of FIGS. 1-3. For example, UE 900 includes controller 280, which operates to execute logic or computer instructions stored in memory 282, as well as controlling the components of UE 900 that provide the features and functionality of UE 900. UE 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO) detector 256, receive processor 258, transmit processor 264, and TX MIMO processor 266.

As shown, memory 282 may include PRACH occasion information 902, beam information 903, beam usage time period information 904, Msg3 transmission information 905, and beam usage determination logic 906. PRACH occasion information 902 may, for example, include one or more times of one or more PRACH transmission occasions. For example, PRACH occasion information 902 may include one or more times of one or more PRACH transmission occasions for transmission of a PRACH transmission, such as a random access preamble or Msg1 transmission, and one or more repetitions of the PRACH transmission. Beam information 903 may, for example, include information regarding one or more beams to be used in transmitting a PRACH transmission, one or more repetitions of the PRACH transmission, a Msg3 transmission, and one or more repetitions of the Msg3 transmission. The beam information 903 may, for example, include information regarding directions of one or more beams, such as TCI state information for one or more beams QCL state information for one or more beams, uplink spatial filtering configurations for one or more beams, or other information for one or more beams. Beam usage time period information 904 may, for example, include one or more time periods for usage of one or more beams for transmission of PRACH transmissions. For example, beam usage time period information 904 may include a first time period for transmission of PRACH transmissions using a first beam and a second time period for transmission of PRACH transmissions using a second beam. Beam usage time period information 904 may, for example, include information regarding particular PRACH transmission occasions that occur during particular time periods for usage of particular beams for PRACH transmissions. Beam usage time period information 904 may also include one or more coherence times for the UE 900, such as one or more coherence times determined by the UE 900 or by a base station, such as base station 800. Msg3 transmission information 905 may include a number of Msg3 transmissions, such as a number of a first Msg3 transmission and one or more repetitions of the Msg3 transmission, to be transmitted by the UE 900 and timing information for the Msg3 transmissions. Msg3 transmission information 905 may include scheduling information for Msg3 transmissions received from the base station 800 in a Msg2 transmission. The beam usage determination logic 906 may be configured to determine time periods for usage of different beams for transmission of a PRACH transmissions, such as a PRACH transmission and one or more repetitions of the PRACH transmission. Such a determination may include determination of time periods for usage of different beams based on a coherence time. The beam usage determination logic 906 may further determine which PRACH transmission occasions for transmission of a PRACH transmission and repetitions of the PRACH transmission occur during specific time periods and therefore which beams should be used for transmission of PRACH transmissions at particular PRACH transmission occasions. The beam usage determination logic 906 may determine one or more beams for usage in transmission of one or more Msg3 transmissions, such as a Msg3 transmission and one or more repetitions of a Msg3 transmission. Such a determination may include determination of one or more beams for usage in transmission of one or more Msg3 transmissions based on a total number of Msg3 repetitions that will be transmitted in response to one or more PRACH transmissions. Beam usage determination logic 906 may also determine a coherence time as described herein. UE 900 may receive signals from or transmit signals to one or more network entities, such as base station 800 of FIGS. 1-3 or a base station as illustrated in FIG. 8.

In one or more aspects, techniques for supporting PRACH repetition using different beams may include additional aspects, such as any single aspect or any combination of aspects described below or in connection with one or more other processes or devices described elsewhere herein. In a first aspect, supporting PRACH repetition using different beams may include an apparatus configured to determine that a first PRACH transmission occasion occurs during a first time period, wherein the first time period is a first time period for which the apparatus is configured to transmit PRACH transmissions using a first beam, determine that a second PRACH transmission occasion occurs during a second time period, wherein the second time period is a second time period for which the apparatus is configured to transmit PRACH transmissions using a second beam, different from the first beam, transmit a first PRACH transmission at the first PRACH transmission occasion using the first beam based on the determination that the first PRACH transmission occasion occurs during the first time period, and transmit a second PRACH transmission at the second PRACH transmission occasion using the second beam based on the determination that the second PRACH transmission occasion occurs during the second time period, wherein the second PRACH transmission is a repetition of the first PRACH transmission. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with one or more of the above aspects, the apparatus is further configured to determine that a third PRACH transmission occasion occurs during the first time period, and transmit a third PRACH transmission at the third PRACH transmission occasion using the first beam based on the determination that the third PRACH transmission occasion occurs during the first time period, wherein the third PRACH transmission is a repetition of the first PRACH transmission.

In a third aspect, alone or in combination with one or more of the above aspects, the apparatus is further configured to determine a coherence time for the UE, determine the first time period based on the coherence time, and determine the second time period based on the coherence time, wherein a first duration of the coherence time is equal to a second duration of the first time period and a third duration of the second time period.

In a fourth aspect, alone or in combination with one or more of the above aspects, the apparatus is further configured to determine the coherence time by at least one of reading a coherence time from a memory of the UE or receiving an indication of the coherence time from a first network node.

In a fifth aspect, alone or in combination with one or more of the above aspects, the apparatus is further configured to receive an indication of the coherence time from the first network node by at least one of receiving the indication of the coherence time in a system information block one (SIB1) transmission from the first network node or receiving the indication of the coherence time in a radio resource control (RRC) transmission from the first network node.

In a sixth aspect, alone or in combination with one or more of the above aspects, the apparatus is further configured to determine the coherence time based on at least one of a frequency range for the UE, a frequency band for the UE, a PRACH format for the UE, or a time domain window (TDW) for demodulation reference signal (DMRS) bundling for the UE.

In a seventh aspect, alone or in combination with one or more of the above aspects, the apparatus is further configured to determine a number of a plurality of message three (Msg3) transmissions associated with the first PRACH transmission and the second PRACH transmission, transmit a first set of the plurality of Msg3 transmissions using the first beam based on the number of the plurality of Msg3 transmissions and transmission of the first PRACH transmission using the first beam, and transmit a second set of the plurality of Msg3 transmissions using the second beam based on the number of the plurality of Msg3 transmissions and transmission of the second PRACH transmission using the second beam, wherein the second set comprises one or more repetitions of a first Msg3 transmission of the first set.

In an eighth aspect, alone or in combination with one or more of the above aspects, the apparatus is further configured to determine the number by at least one of receiving the number in a message two (Msg2) transmission from the first network node or receiving the number in a downlink control information (DCI) transmission from the first network node.

In one or more aspects, techniques for supporting PRACH repetition using different beams may include additional aspects, such as any single aspect or any combination of aspects described below or in connection with one or more other processes or devices described elsewhere herein. In a ninth aspect, supporting PRACH repetition using different beams may include an apparatus configured to determine a coherence time for a UE based on one or more transmission parameters of the UE, transmit an indication of the coherence time to the UE, and receive a first physical random access channel (PRACH) transmission from the UE using a first beam at a first PRACH transmission occasion after transmission of the indication of the coherence time. Additionally, the apparatus may perform or operate according to one or more aspects as described below. In some implementations, the apparatus includes a wireless device, such as a first network node or base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a tenth aspect, alone or in combination with one or more of the above aspects, the first PRACH transmission is transmitted by the UE using the first beam at the first PRACH transmission occasion based on a determination by the UE that the first PRACH transmission occasion occurs during a first time period, and wherein the first time period is determined by the UE based on the coherence time.

In an eleventh aspect, alone or in combination with one or more of the above aspects, the apparatus is configured to receive a second physical random access channel (PRACH) transmission from the UE using the first beam at a second PRACH transmission occasion, wherein the second PRACH transmission is transmitted by the UE using the first beam at the second PRACH transmission occasion based on a determination by the UE that the second PRACH transmission occasion occurs during the first time period, and wherein the second PRACH transmission is a repetition of the first PRACH transmission.

An a twelfth aspect, alone or in combination with one or more of the above aspects, the one or more transmission parameters of the UE comprise at least one of a frequency range for the UE, a frequency band for the UE, a PRACH format for the UE, or a time domain window (TDW) for demodulation reference signal (DMRS) bundling for the UE.

In a thirteenth aspect, alone or in combination with one or more of the above aspects, the apparatus is configured to transmit an indication of the coherence time to the UE by at least one of transmitting the indication of the coherence time in a system information block one (SIB1) transmission or transmitting the indication of the coherence time in a radio resource control (RRC) transmission.

In a fourteenth aspect, alone or in combination with one or more of the above aspects, the apparatus is configured to transmit, to the UE, a number of a plurality of message three (Msg3) transmissions associated with the first PRACH transmission to be transmitted by the UE and receive a first set of the plurality of Msg3 transmissions transmitted by the UE using the first beam, wherein the first set of the plurality of Msg3 transmissions is transmitted by the UE based on the number of the plurality of Msg3 transmissions and transmission of the first PRACH transmission using the first beam.

In a fifteenth aspect, alone or in combination with one or more of the above aspects, the apparatus is configured to transmit the number of the plurality of Msg3 transmissions by transmitting the number in a message two (Msg2) transmission or transmitting the number in a downlink control information (DCI) transmission.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 and 8-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
determining that a first PRACH transmission occasion occurs during a first time period, wherein the first time period is a first time period for which the UE is configured to transmit PRACH transmissions using a first beam;
determining that a second PRACH transmission occasion occurs during a second time period, wherein the second time period is a second time period for which the UE is configured to transmit PRACH transmissions using a second beam, different from the first beam;
transmitting a first PRACH transmission at the first PRACH transmission occasion using the first beam based on the determination that the first PRACH transmission occasion occurs during the first time period; and
transmitting a second PRACH transmission at the second PRACH transmission occasion using the second beam based on the determination that the second PRACH transmission occasion occurs during the second time period, wherein the second PRACH transmission is a repetition of the first PRACH transmission.

2. The method of claim 1, further comprising:
determining that a third PRACH transmission occasion occurs during the first time period; and
transmitting a third PRACH transmission at the third PRACH transmission occasion using the first beam based on the determination that the third PRACH transmission occasion occurs during the first time period,
wherein the third PRACH transmission is a repetition of the first PRACH transmission.

3. The method of claim 1, further comprising:
determining a coherence time for the UE,
determining the first time period based on the coherence time; and
determining the second time period based on the coherence time,
wherein a first duration of the coherence time is equal to a second duration of the first time period and a third duration of the second time period.

4. The method of claim 3, wherein determining the coherence time comprises at least one of:
reading a coherence time from a memory of the UE; or
receiving an indication of the coherence time from a first network node.

5. The method of claim 4, wherein receiving the indication of the coherence time from the first network node comprises at least one of:
receiving the indication of the coherence time in a system information block one (SIB1) transmission from the first network node; or
receiving the indication of the coherence time in a radio resource control (RRC) transmission from the first network node.

6. The method of claim 3, wherein the coherence time is determined based on at least one of:
a frequency range for the UE;
a frequency band for the UE;
a PRACH format for the UE; or
a time domain window (TDW) for demodulation reference signal (DMRS) bundling for the UE.

7. The method of claim 1, further comprising:
determining a number of a plurality of message three (Msg3) transmissions associated with the first PRACH transmission and the second PRACH transmission;
transmitting a first set of the plurality of Msg3 transmissions using the first beam based on the number of the plurality of Msg3 transmissions and transmission of the first PRACH transmission using the first beam; and
transmitting a second set of the plurality of Msg3 transmissions using the second beam based on the number of the plurality of Msg3 transmissions and transmission of the second PRACH transmission using the second beam,
wherein the second set comprises one or more repetitions of a first Msg3 transmission of the first set.

8. The method of claim 7, wherein determining the number comprises at least one of:
receiving the number in a message two (Msg2) transmission from a first network node; or
receiving the number in a downlink control information (DCI) transmission from the first network node.

9. A user equipment (UE) comprising:
a memory; and
at least one processor coupled to the memory, wherein the at least one processor is configured to:
determine that a first PRACH transmission occasion occurs during a first time period, wherein the first time period is a first time period for which the UE is configured to transmit PRACH transmissions using a first beam;
determine that a second PRACH transmission occasion occurs during a second time period, wherein the second time period is a second time period for which the UE is configured to transmit PRACH transmissions using a second beam, different from the first beam;
transmit a first PRACH transmission at the first PRACH transmission occasion using the first beam based on the determination that the first PRACH transmission occasion occurs during the first time period; and
transmit a second PRACH transmission at the second PRACH transmission occasion using the second beam based on the determination that the second PRACH transmission occasion occurs during the second time period, wherein the second PRACH transmission is a repetition of the first PRACH transmission.

10. The UE of claim 9, wherein the at least one processor is further configured to:
determine that a third PRACH transmission occasion occurs during the first time period; and
transmit a third PRACH transmission at the third PRACH transmission occasion using the first beam based on the determination that the third PRACH transmission occasion occurs during the first time period,
wherein the third PRACH transmission is a repetition of the first PRACH transmission.

11. The UE of claim 9, wherein the at least one processor is further configured to:
determine a coherence time for the UE;
determine the first time period based on the coherence time; and
determine the second time period based on the coherence time,
wherein a first duration of the coherence time is equal to a second duration of the first time period and a third duration of the second time period.

12. The UE of claim 11, wherein the at least one processor is configured to determine the coherence time by at least one of:
reading a coherence time from the memory of the UE; or
receiving an indication of the coherence time from a first network node.

13. The UE of claim 12, wherein the at least one processor is configured to receive the indication of the coherence time from the first network node by at least one of:
receiving the indication of the coherence time in a system information block one (SIB1) transmission from the first network node; or
receiving the indication of the coherence time in a radio resource control (RRC) transmission from the first network node.

14. The UE of claim 11, wherein the at least one processor is configured to determine the coherence time based on at least one of:
a frequency range for the UE;
a frequency band for the UE;
a PRACH format for the UE; or
a time domain window (TDW) for demodulation reference signal (DMRS) bundling for the UE.

15. The UE of claim 9, wherein the at least one processor is further configured to:
determine a number of a plurality of message three (Msg3) transmissions associated with the first PRACH transmission and the second PRACH transmission;
transmit a first set of the plurality of Msg3 transmissions using the first beam based on the number of the plurality of Msg3 transmissions and transmission of the first PRACH transmission using the first beam; and
transmit a second set of the plurality of Msg3 transmissions using the second beam based on the number of the plurality of Msg3 transmissions and transmission of the second PRACH transmission using the second beam,
wherein the second set comprises one or more repetitions of a first Msg3 transmission of the first set.

16. The UE of claim 15, wherein the at least one processor is configured to determine the number by at least one of:
receiving the number in a message two (Msg2) transmission from a first network node; or
receiving the number in a downlink control information (DCI) transmission from the first network node.

17-23. (canceled)

24. A first network node, comprising:
a memory; and
at least one processor coupled to the memory, wherein the at least one processor is configured to:
determine a coherence time for a user equipment (UE) based on one or more transmission parameters of the UE;
transmit an indication of the coherence time to the UE; and
receive a first physical random access channel (PRACH) transmission from the UE using a first beam at a first PRACH transmission occasion after transmitting the indication of the coherence time.

25. The first network node of claim 24, wherein the first PRACH transmission is transmitted by the UE using the first beam at the first PRACH transmission occasion based on a determination by the UE that the first PRACH transmission occasion occurs during a first time period, and wherein the first time period is determined by the UE based on the coherence time.

26. (canceled)

27. The first network node of claim 24, wherein the one or more transmission parameters of the UE comprise at least one of:
a frequency range for the UE;
a frequency band for the UE;
a PRACH format for the UE; or
a time domain window (TDW) for demodulation reference signal (DMRS) bundling for the UE.

28. (canceled)

29. The first network node of claim 24, wherein the at least one processor is further configured to:
transmit, to the UE, a number of a plurality of message three (Msg3) transmissions associated with the first PRACH transmission to be transmitted by the UE; and
receive a first set of the plurality of Msg3 transmissions transmitted by the UE using the first beam, wherein the first set of the plurality of Msg3 transmissions is transmitted by the UE based on the number of the plurality of Msg3 transmissions and transmission of the first PRACH transmission using the first beam.

30. (canceled)
